(19) United States
(12) Patent Application Publication
(10) Pub. No.: US 2011/0063825 A1
(43) Pub. Date: Mar. 17, 2011

(54) CUPULATE LIGHT

(76) Inventor: Chi-Wen CHENG, Dongguan (CN)

(21) Appl. No.: 12/562,112

(22) Filed: Sep. 17, 2009

(51) Int. Cl. F21L 4/00

(52) U.S. Cl. 362/190

(57) ABSTRACT

A cupulate light essentially contains a light assembly and a suction assembly spirally installed on the light assembly. A casing disposed on the soft suction member compresses the periphery of the suction member to prevent an air leak out of the periphery thereof, which enhances the suction capability of the product. Such parts reasonably designed as the transparent lampshade, positioning lampshade, and battery container are sequentially installed into the housing. Therefore, the positioning lampshade and the transparent lampshade limited in the housing through the battery case would conduce to a great assembling efficiency. The light and suction assemblies in detachment enhance an efficient replacement by merely changing broken parts thereof, which prevents the waste of entire product and the unnecessary wastefulness to achieve an efficiency of energy saving and environment protecting.

### BACKGROUND OF THE INVENTION

1. Field of the Invention

The present invention relates to a cupulate light, in particular to the cupulate light that has a compact structure, a convenient fabrication, and a superior suction power.

2. Description of the Related Art

Generally speaking, a cupulate light is directed to a product that combines the functions of a lamp and a cupule. Substantially, the cupule is disposed at the bottom of the lamp for directly sticking the lamp on any glossy surface, such as glass, or the walls in the bathroom or kitchen, thus preventing from damaging the glass or walls. Various cupulate lights existing in the market all serve with basic functions, such as functions of illumination and suction power. However, deficiencies still exist in the structures and using functions of the present cupulate lights, incurring the unsatisfactory using efficiency and working competence as follows:
1. The suction configuration of the typical cupulate light essentially adopts a single-soft cupule. However, the suction of such single-soft cupule is limited because it facilely incurs an air leak out of the border of the cupule and affects the adhesion and endurance of the product.
2. The lamp and the cupule of the existing cupulate light are inseparable. Therefore, while merely one part of the cupulate light is damaged, the entire cupulate light including the lamp and the cupule become useless, resulting in an inconvenient substitution and unnecessary wastefulness.
3. The housing of the existing cupulate light has an unreasonable design, which requires a complicated fabrication and severely influences an assembling efficiency of the product configuration.

### SUMMARY OF THE INVENTION

The present invention providing an improved cupulate light employs a simple structural design and uncomplicated assemblage. It is an object of the present invention to prevent the existing cupulate light from wanting in sufficient suction via providing the cupulate light with greater suction. Another object of the present invention is to avert the existing cupulate light from complicated fabrication through providing the parts for the cupulate light with a convenient assemblage. Another object of the present invention is to apply a cupulate light having separate light member and suction member to achieve the product's convenience of using and maintenance.

The present invention in conformity with the present invention applies the following techniques:

A cupulate light comprises a light assembly and a suction assembly spirally installed on the light assembly. Wherein, the light assembly includes a housing, a transparent lampshade, an illuminant member, and a battery container. The housing has a lower opening formed with an assembling entrance and an upper opening formed with a transparent orifice. Moreover, the transparent lampshade, the illuminant member, and the battery container are sequentially fixed to the housing through the assembling entrance at the lower opening. Further, the transparent lampshade covers on the transparent orifice, and the illuminant member is fixed between the transparent lampshade and the battery container, so that batteries in the battery container would provide the illuminant member with sufficient electricity. Additionally, the battery container further includes a female bolt disposed thereon. As to the suction assembly, it includes a casing, a male bolt, and a soft suction member. Wherein, the male bolt integrally protrudes from a top of the soft suction member and removable fits with the female bolt, by which the casing disposed on the male bolt would prop against a periphery of the soft suction member.

Preferably, the casing includes a first flat top, a supporting portion downwardly extended from a periphery of the first flat top, and a brim section disposed at an extended end of the supporting portion. Wherein, the first flat top has an accommodation formed therebelow and an aperture formed at a center thereof. In addition, the soft suction member has a second flat top, a connecting portion downwardly extended from a periphery of the second flat top, and a compressed section formed at an extended end of the connector. Wherein, the second flat top has a sucking room formed therebelow. Further, the soft suction member is disposed within the accommodation, the first flat top is disposed over the second flat top, and a backside of the compressed section is overlaid by the brim section. The male bolt is embedded in the second flat top for uprightly penetrating through the aperture of the first flat top.

Preferably, barbs are disposed on an inner wall of the housing, and elastic buckles are correspondingly disposed at a side of a battery upper cover of the battery container, which allows the elastic buckles to engage with the barbs so as to form a connection between the battery container and the housing.

Preferably, a battery lower cover is fastened to a battery upper cover via screwing fasteners in the direction from a bottom toward a top.

Preferably, the batteries adopts three cylinder dry batteries, which display a triangle by connecting each one front to another adjacent end, so that a space is encircled at a center thereof for the female bolt to be disposed therein.

Preferably, the housing further includes a decorative ring to surround an outer surface of the transparent lampshade.

Preferably, the decorative ring buckles on the outer surface of the housing in a direction from a top to a bottom.

Accordingly, the present invention performs the following advantages:
1. A greater suction is introduced by the soft suction member added with a casing thereon, so that the casing could compress the border of the soft suction member. Accordingly, an air leak out of the border of the soft suction member could be preferably avoided to solve the deficiency of poor suction and achieve a greater sucking power.
2. A more convenient fabrication is provided by the parts included in the reasonable designed light member of the cupulate light. In fabrication, the illuminant member is firstly fixed to the upper surface of the battery container. Correspondingly, the transparent lampshade, the positioning lampshade, and the battery container are sequentially put into the housing through the assembling entrance of the housing. Thereby, the battery container and the housing are engaged via a hooking relationship, and the positioning lampshade and the transparent lampshade would be both fixed in the housing through the battery container. Accordingly, such assembly means and mounting orders enhance the efficiency of production and fabrication. Especially in a mass production, the working time and cost would be both decreased.
3. A promoted applicability is developed by the partible light assembly and the suction member provided with a spiral connection. Namely, the light assembly and the suction member are formed as a separable structure. Therefore, when either the light member or the suction member is damaged, the substitution of the damaged member could be merely executed, which prevents the waste of entire product and unnecessary wastefulness to achieve the efficiency of energy saving and environment protecting.
4. A more attractive appearance is obtained by a positioning lampshade provided to cover a circuit board, so that a favorable appearance of the inner part of the light assembly would be seen through the transparent lampshade. Further, a decorative ring with multiple colors and contours in conformity with client's requirement are disposed on the periphery of the housing, hence promoting variations in shape as well as pattern and reinforcing a pleasant appearance of the entire cupulate light.
5. A compact structure of the product is achieved by the reasonable arrangement. Wherein, the three batteries in the battery container display a triangle by connecting each one front to another adjacent end, so that a space is encircled at a center thereof for the female bolt to be disposed therein and for the correspondent male bolt of the suction member to protrude thereto. Therefore, the space within the product is fully utilized to obtain a dense assemblage.

The advantages of the present invention over the known prior arts will become more apparent to those of ordinary skilled in the art by reading the following descriptions with the relating drawings.

### BRIEF DESCRIPTION OF THE DRAWINGS

FIG. 1 is a perspective view showing the present invention;

FIG. 2 is a perspective view showing the separate light assembly and suction assembly of the present invention;

FIG. 3 is an exploded view showing the light assembly of the present invention;

FIG. 4 is an exploded view showing the suction member of the present invention;

FIG. 5 is a cross-sectional view showing the present invention;

FIG. 6 is another cross-sectional view showing FIG. 5;

FIG. 7 is a cross-sectional view showing the suction member of the present invention; and

FIG. 8 is an enlarged view showing the housing and the upper cover of the present invention.

### DESCRIPTION OF ELEMENTS IN THE DRAWINGS

| | | | |
|---|---|---|---|
| 10 | light assembly | 101 | assembling |
| | | | entrance |
| 102 | transparent orifice | 103 | space |
| 11 | housing | 111 | upend hook |
| 12 | positioning lampshade | 13 | transparent |
| | | | lampshade |
| 14 | decorative ring | 15 | illuminant member |
| 151 | LED light | 152 | circuit board |
| 16 | battery container | 161 | battery upper |
| | | | cover |
| 1611 | elastic buckle | 162 | batteries |
| 163 | battery lower cover | 164 | through hole |
| 17 | female bolt | | |
| 20 | suction member | 21 | casing |
| 211 | first flat top | 212 | supporting portion |
| 213 | brim section | 22 | male bolt |
| 221 | lower part | 222 | upper part |
| 23 | soft suction member | 231 | second flat top |
| 232 | connecting portion | 233 | compressed |
| | | | section |

### DETAILED DESCRIPTION OF THE PREFERRED EMBODIMENTS

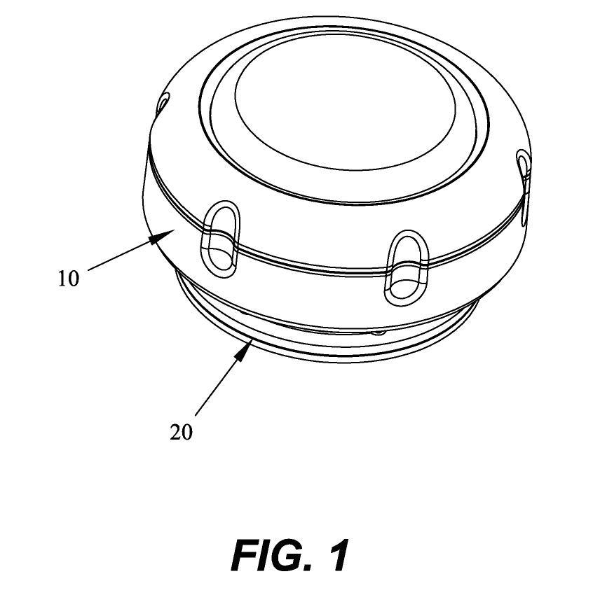

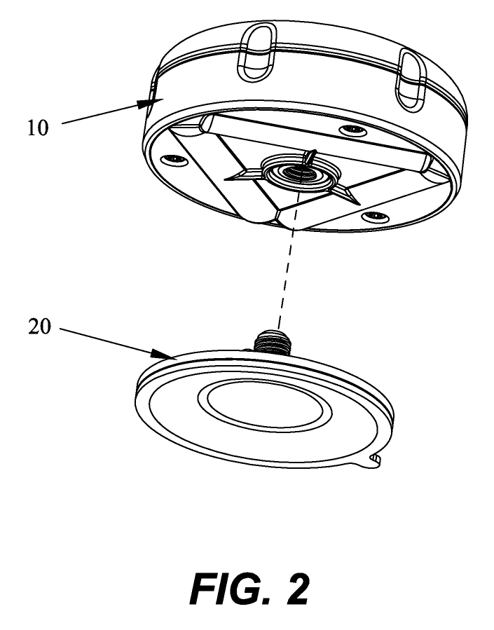

Referring to FIGS. 1 to 8 showing the present invention comprises a light assembly 10 and a suction assembly 20 spirally installed on a bottom of the light assembly 10.

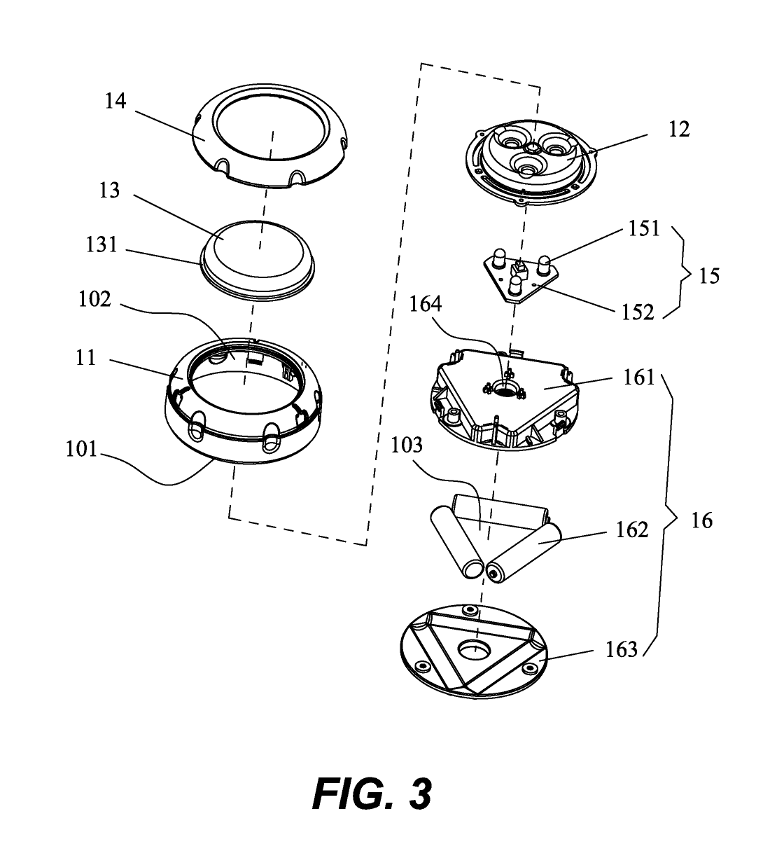

Substantially referring to FIGS. 3, 5, and 8, the light assembly 10 includes a housing 11, a positioning lampshade 12, a transparent lampshade 13, a decorative ring 14, an illuminant member 15, and a battery container 16. Wherein, the housing 11 is directed to a plastic annular thin shell with a hollow interior. The housing 11 has a lower opening formed with an assembling entrance 101 and an upper opening formed with a transparent orifice 102.

The transparent lampshade 13, positioning lampshade 12, the illuminant member 15, and the battery container 16 are sequentially fixed to the housing 11 through the assembling entrance 101. Batteries 162 in the battery container 16 would provide the illuminant member 15 with sufficient electricity. The transparent lampshade 13 covers the transparent orifice 102 of the housing 11, so that an edge 131 on the periphery could engage to the inner margin of the transparent orifice 102 to limit the transparent lampshade 13 without escaping from the transparent orifice 102. In addition, the positioning lampshade 12 and the illuminant member 15 are fixed between the transparent lampshade 13 and the battery container 16. Herein the illuminant member adopts three LED lights 151 fixed to a same circuit board 152 that is then covered by the positioning lampshade 12. Therefore, the inner part of the light member 10 shown through the transparent lampshade 13 would perform a favorable appearance. Wherein, the three LED lights 151 would penetrate through the positioning lampshade 12 and protrude therefrom, so that the light could be sent out of the light assembly 10 through the transparent lampshade 13 to obtain the illumination while conducting electricity.

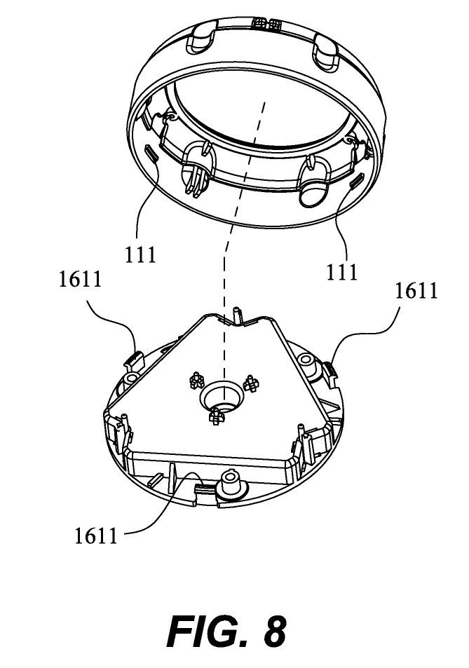

The battery container 16 includes a battery upper cover 161, a battery lower cover 163, and batteries 162. Wherein, the battery lower cover 163 screws to the battery upper cover 161 via the male bolt, and the batteries 162 are disposed within the battery upper cover 161 and the battery lower cover 163. An upright through hole 164 is defined at the center of the battery upper cover 161 for a female bolt 17 to be fixed therein. The batteries 162 in the embodiment adopt three cylinder dry batteries, which display a triangle by connecting each one front to another adjacent end, so that a space 103 is encircled at a center thereof for the through hole 164 and the female bolt 17 to be disposed therein. Referring to FIG. 8, three elastic buckles 1611 are upwardly disposed at the periphery of the battery upper cover 161, and three barbs 111 are correspondingly disposed on an inner wall of the housing 11. The elastic buckles 1611 serve to hook over the barbs 111, so that the battery container 16 could be fixed in the housing 11 in a direction from the bottom to top via the assembling entrance 101 without escaping therefrom.

The decorative ring 14 buckles to the outer surface of the housing 11 in a direction from a top to a bottom as well as surrounds the outer surface of the transparent lampshade 13. By means of the various colors and contours applied to the decorative ring 14, the cupulate light would possess the attractive appearance.

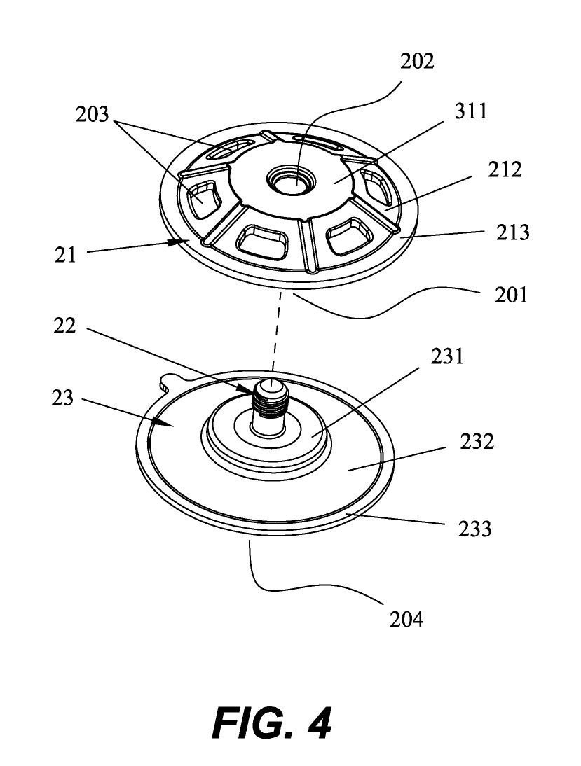

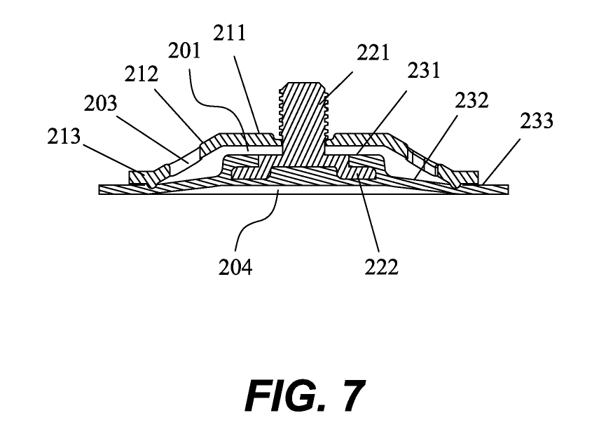

Referring to FIGS. 4 and 7, the suction assembly 20 includes a plastic casing 21, a metal male bolt 22, and a rubber soft suction member 23. The male bolt 22 is covered by the casing 21 to compress the periphery of the soft suction member 23.

Substantially, the casing 21 includes a first flat top 211, a supporting portion 212, and a brim section 213. Wherein, the supporting portion 212 is downwardly extended from a periphery of the first flat top 211, and the brim section 213 is disposed at an extended end of the supporting portion 212. Moreover, the first flat top 211 has an accommodation 201 formed therebelow and an aperture 202 formed at a center thereof. The supporting portion 212 includes a plurality of vents 203 disposed thereon.

The soft suction member 23 has a second flat top 231, a connecting portion 232, and a compressed section 233. Wherein, the connecting portion 232 is downwardly extended from a periphery of the second flat top 231, and the compressed section 233 is formed at an extended end of the connecting portion 232. The second flat top has a sucking room 204 formed therebelow. The soft suction member 23 is disposed within the accommodation 201, the first flat top 211 is disposed over the second flat top 231, and a backside of the compressed section 233 is overlaid by the brim section 213 of the casing 21.

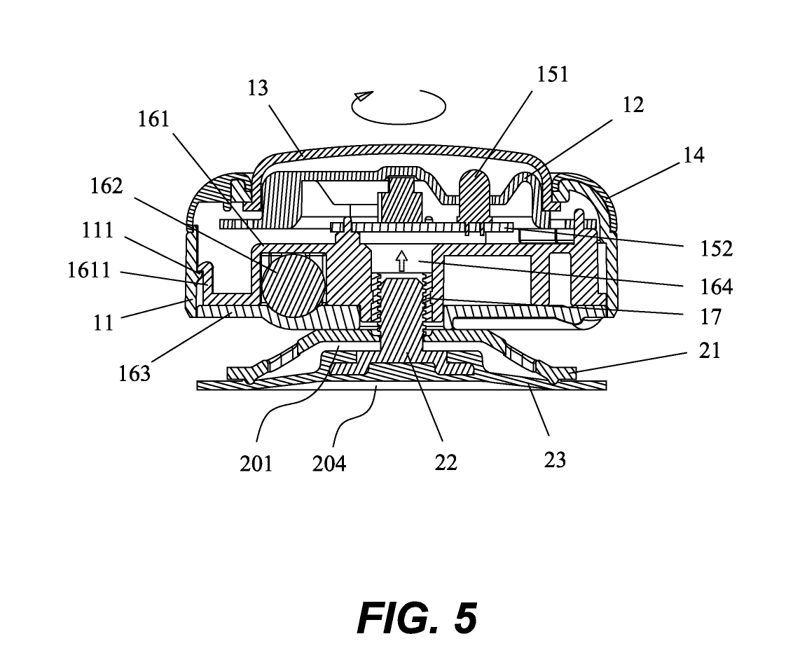

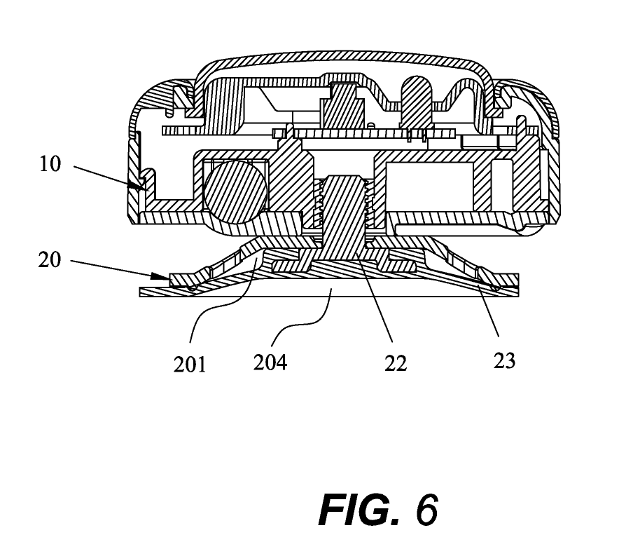

A lower part 221 of the metal male bolt 22 is embedded in the center of the second flat top 231 of the rubber soft suction member 23, so that an upper part 222 of the male bolt 22 could be upwardly extended from the top of the soft suction member 23. While the male bolt 22 uprightly penetrates through the aperture 202, it is removably and rotably screwed to the female bolt 17 (as shown by FIGS. 5 and 6).

In using, the sucking room 204 of the soft suction member 23 is previously adhered to any glossy surface, such as ceramic tile or glass. Further, the light member 10 would be rotated as shown in FIGS. 5 and 6 and the male bolt 22 of the suction assembly 20 would be upwardly pulled during the rotation. Whereby, the first flat top 211 of the casing 21 would be continuously pushed so as to adopt the supporting portion 213 thereof to compactly prop against the compressed section 233 of the soft suction member 23. Namely, the periphery of the soft suction member 23 is tightly compressed. Therefore, an air leak out of the periphery of the soft suction member 23 could be preferably prevented to achieve a superior suction and a greater suction durability.

To sum up, the present invention achieves the following advantages:
1. By the soft suction member added with a casing thereon, the casing could compress the border of the soft suction member. Accordingly, an air leak out of the border of the soft suction member could be preferably avoided to avert the deficiency of poor suction and to introduce a greater sucking power.
2. The parts are included in the reasonable designed light member of the cupulate light. In fabrication, the illuminant member is firstly fixed to the surface of the battery container. Correspondingly, the transparent lampshade, the positioning lampshade, and the battery container are sequentially put into the housing through the assembling entrance of the housing. Thereby, the battery container and the housing are interlocked, and the positioning lampshade and the transparent lampshade would be both fixed in the housing through the battery container. Accordingly, such assembly means and orders enhance the efficiency of production and fabrication. While being manufacture by mass production, the working time and cost would be both decreased.
3. The partible light assembly and the suction member provide a separable structure through the removable and spiral relationship therebetween. Therefore, when one of the light member and the suction member is damaged, the replacement could be merely executed on the damaged member, which prevents the waste of entire product and unnecessary wastefulness to achieve an efficiency of energy saving and environment protecting.
4. The positioning lampshade is provided to cover the circuit board, so that the inner part of the light assembly with a favorable appearance would be exposed to the outside through the transparent lampshade. Further, a decorative ring with multiple colors and contours as designed by requirement disposed on the periphery of the housing further promotes the look as well as the pattern to higher flexibility, hence reinforcing a pleasant appearance of the entire cupulate light.
5. The present invention having a reasonable arrangement, in which the three batteries display a triangle concatenation by connecting each one front to another adjacent end, so that a space is encircled at a center thereof for the female bolt to be disposed therein, and for the correspondent male bolt of the suction member to protrude thereto. Therefore, the space of the product is fully utilized to obtain a concise structure thereof.

While we have shown and described the embodiment in accordance with the present invention, it should be clear to those skilled in the art that further embodiments may be made without departing from the scope of the present invention.

I claim:

1. A cupulate light, characterized in that said cupulate light comprising a light assembly and a suction assembly spirally installed on said light assembly; wherein,
said light assembly including a housing, a transparent lampshade, an illuminant member, and a battery container; said housing having a lower opening formed with an assembling entrance and an upper opening formed with a transparent orifice; said transparent lampshade, said illuminant member, and said battery container being sequentially fixed to said housing through said assembling entrance at said lower opening; said transparent lampshade covering said transparent orifice, and said illuminant member being fixed between said transparent lampshade and said battery container, so that batteries in said battery container providing said illuminant member with sufficient electricity; said battery container further including a female bolt disposed thereon;
said suction assembly including a casing, a male bolt, and a soft suction member; said male bolt integrally protruding from a top of said soft suction member for being removable and screwed into said female bolt so as to be covered by said casing, so that a periphery of said soft suction member would be propped against by said casing.

2. The cupulate light as claimed in claim 1, wherein, said casing includes a first flat top, a supporting portion downwardly extended from a periphery of said first flat top, and a brim section disposed at an extended end of said supporting portion; said first flat top has an accommodation formed therebelow and an aperture formed at a center thereof;
said soft suction member has a second flat top, a connecting portion downwardly extended from a periphery of said second flat top, and a compressed section formed at an extended end of said connecting portion; said second flat top has a sucking room formed therebelow;
said soft suction member is disposed within said accommodation, said first flat top is disposed above said second flat top, and a backside of said compressed section is overlaid by said brim section;
said male bolt is embedded in said second flat top for uprightly penetrating through said aperture of said first flat top.

3. The cupulate light as claimed in claim 1, wherein, barbs are disposed on an inner wall of said housing, and elastic buckles are correspondingly disposed at a side of a battery upper cover of said battery container, which allows said elastic buckles to engage with said barbs so as to form a connection between said battery container and said housing.

4. The cupulate light as claimed in claim 1, wherein, a battery lower cover screws to a battery upper cover of said battery container from a bottom to a top via said male bolt.

5. The cupulate light as claimed in claim 1, wherein, said batteries adopts three cylinder dry batteries, which display a triangle contour by connecting each one front to another adjacent end, so that a space is encircled at a center thereof for said female bolt to be disposed therein.

6. The cupulate light as claimed in claim 1, wherein, said housing further includes a decorative ring to surround an outer surface of said transparent lampshade.

7. The cupulate light as claimed in claim 6, wherein, said decorative ring buckles to said outer surface of said housing in a direction from a top to a bottom.
